(19) United States
(12) Patent Application Publication
(10) Pub. No.: US 2024/0335893 A1
(43) Pub. Date: Oct. 10, 2024

(54) WORKPIECE CHAMFERING

(71) Applicant: FELSOMAT GmbH & Co. KG, Königsbach-Stein (DE)

(72) Inventor: Kris Maria Robert Bogaerts, Quillan (FR)

(73) Assignee: FELSOMAT GmbH & Co. KG, Königsbach-Stein (DE)

(21) Appl. No.: 18/737,952

(22) Filed: Jun. 8, 2024

Related U.S. Application Data
(63) Continuation of application No. PCT/GB2022/053084, filed on Dec. 5, 2022.

(30) Foreign Application Priority Data
Dec. 8, 2021 (GB) 2117716.7

(51) Int. Cl. B23F 5/16; B23F 19/10

(52) U.S. Cl. CPC B23F 5/16; B23F 19/10

(57) ABSTRACT

A workpiece has a plurality of outwardly projecting teeth disposed about the circumference of the workpiece and has a central rotational axis (Z) with the teeth being disposed in a first plane that is perpendicular to the workpiece central axis (Z). A method of chamfering teeth on the workpiece uses a tool which has a plurality of cutting teeth disposed about the circumference of the tool and which has a central rotational tool axis (A) with the cutting teeth disposed in a second plane that is perpendicular to the tool central axis (A).

### CROSS-REFERENCE TO RELATED APPLICATIONS

This continuation application claims priority to PCT/GB2022/053084 filed on Dec. 5, 2022, which has published as WO 2023/105199 A1 and also the United Kingdom patent application number GB 2117716.7 filed on Dec. 8, 2021, the entire contents of which are fully incorporated herein with these references.

### DESCRIPTION

### Field of the Invention

The present invention relates to workpiece chamfering, particularly the chamfering of teeth on a workpiece such as a gear.

### Background of the Invention

The present invention is an improvement over the prior art relating to workpiece chamfering.

### SUMMARY OF THE INVENTION

According to a first aspect of the present invention there is provided a method of chamfering teeth on a workpiece which has a plurality of outwardly projecting teeth disposed about the circumference of the workpiece and which has a central rotational axis (Z) with the teeth being disposed in a first plane that is perpendicular to the workpiece central axis (Z), the method utilizing a tool which has a plurality of cutting teeth disposed about the circumference of the tool and which has a central rotational tool axis (A) with the cutting teeth disposed in a second plane that is perpendicular to the tool central axis (A);
the method comprising:
i. rotating the workpiece in one direction about its central axis (Z);
ii. rotating the tool in an opposite direction about the tool axis (A), the teeth of the tool each having a cutting portion at a leading edge when the tool is rotated in said opposite direction;
iii. moving the tool and the workpiece towards each other, while the tool and the workpiece are rotating such that the teeth of the tool engage the teeth at an axially facing end of the workpiece at a meshing zone (M), the cutting portions of the tool teeth engaging and cutting into the meshing surfaces of the workpiece teeth at the trailing edges of the workpiece teeth thereby to chamfer said trailing edges of the workpiece teeth;
wherein an axis (X) extends perpendicular to the workpiece central axis (Z) through said meshing zone (M), and the tool axis (A) is tilted at an angle about the axis (X) relative to a direction (Z′) which is an imaginary axis which is parallel to workpiece axis (Z) and which extends through the axis (X), such that the second plane is not parallel to, or co-planar with, the first plane only by virtue of the tilting about the axis (X).

The chamfers on the teeth of the workpiece are cut by the action of the meshing of the tool teeth and the workpiece teeth. Gear chamfering is beneficial for smooth gear meshing and quiet gears require more accurate chamfers. Because the material is cut away in the present chamfering process it reduces problems such as brittleness in the chamfer area after heat treatment and/or grinding.

Preferably, the tilt angle about the axis (X) is up to 15°. More preferably the tilt angle about the axis (X) is up to 10°.

In some methods according to the invention the tool is moved towards the workpiece in step iii, the workpiece not moving along its central axis (Z), the tool being moved in one or a combination of:
a. a direction parallel to direction of the axis (Z′),
b. a direction parallel to the direction of the axis (X),
c. a direction parallel to an axis (Y) which is perpendicular to axes X and Z.

Usually, the leading edges of the workpiece teeth are chamfered by a reversal of steps i to iii utilizing a tool which has a plurality of cutting teeth disposed about the circumference of the tool and which has a central rotational tool axis (A′) with the cutting teeth disposed in a second plane that is perpendicular to the tool central axis (A′) and the teeth of the tool each having a cutting portion at a leading edge when the tool is rotated in said one direction, namely:
iv. rotating the workpiece in the opposite direction about its central axis (Z) such that the leading edges of the workpiece teeth are effectively trailing edges;
V. rotating the tool in the first direction about the tool axis (A′);
vi. moving the tool and the workpiece towards each other such that the teeth of the tool engage the teeth at said axially facing end of the workpiece at the meshing zone (M), the second cutting portions of the tool teeth engaging and cutting into the now trailing leading edges of the workpiece thereby to chamfer said leading edges of the workpiece teeth;
   wherein the tool axis (A′) is tilted at an angle about the axis (X) in the opposite direction relative to direction (Z′) and extends through the axis (X) such that the second plane is not parallel to, or co-planar with, the first plane only by virtue of the tilting about the axis (X).

Commonly, the tool utilized to chamfer the trailing edges of the workpiece teeth is a separate tool to the tool utilized to chamfer the leading edges of the workpiece teeth.

Usually, the tool teeth are provided on the cutting tool such that the cutting portions of the teeth are radially spaced from the central tool axis (A) and extend at an angle relative to the central tool axis. In preferred methods the tool teeth depend from a central disc portion outwardly therefrom at said angle to the tool axis.

Normally, the method further comprises the step of providing control means to control (a) the movement of the tool or tools and the workpiece towards each other and (b) the relative speeds of rotation of the tool and the workpiece in order to control the amount of chamfer and the rate of material removal in the chamfering process. Preferably the control means is configured to control the distance between the workpiece axis (Z) and the imaginary axis (Z′) so as to control the radial extent of the chamfer formed on the workpiece teeth.

Often, the axially facing opposite ends of the teeth of the workpiece are chamfered simultaneously with the first-mentioned axially facing ends of the workpiece, the method comprising the step of providing a further tool similar to the first-mentioned tool and effecting steps i to iii on the axially opposite facing ends of teeth of the workpiece, the further tool being positioned so as not to interfere with the first-mentioned tool during chamfering.

According to a second aspect of the present invention there is provided a method of chamfering teeth on a workpiece which has a plurality of inwardly projecting teeth disposed about the circumference of the workpiece and which has a central rotational axis (Z) with the teeth being disposed in a first plane that is perpendicular to the workpiece central axis (Z), the method utilizing a tool which has a plurality of cutting teeth disposed about the circumference of the tool and which has a central rotational tool axis (A) with the cutting teeth disposed in a second plane that is perpendicular to the tool central axis (A);

the method comprising:
i. rotating the workpiece in one direction about its central axis (Z);
ii. rotating the tool in said one direction about the tool axis (A), the teeth of the tool each having a cutting portion at a leading edge when the tool is rotated in said one direction;
iii. moving the tool and the workpiece towards each other, while the tool and the workpiece are rotating, in a direction (Z′) which is parallel to the workpiece central axis (Z) such that the teeth of the tool engage the teeth at an axially facing end of the workpiece at a meshing zone (M), the cutting portions of the tool teeth engaging and cutting into the meshing surfaces of the workpiece teeth at the trailing edges of the workpiece teeth thereby to chamfer said trailing edges of the workpiece teeth;
   wherein an axis (X) extends perpendicular to the workpiece central axis (Z) through said meshing zone (M), and the tool axis (A) is tilted at an angle about the axis (X) relative to the direction (Z′) which is an imaginary axis which is parallel to workpiece axis (Z) and which extends through the axis (X), such that the second plane is not parallel to, or co-planar with, the first plane only by virtue of the tilting about the axis (X).

According to another aspect of the present invention there is provided a tool for use in the chamfering of teeth on a workpiece which has a plurality of projecting teeth disposed about the circumference of the workpiece, the tool having:
a central disc portion;
a central rotational tool axis, the central disc portion extending in a first general plane that is perpendicular to the central rotational tool axis; and
a plurality of cutting teeth disposed about the outer circumference of the tool;
   wherein the teeth of the tool each have a cutting portion at a leading edge when the tool is rotated in one direction about said central rotational tool axis such that the cutting portions of the teeth are radially spaced from the central tool axis and all the cutting portions would be disposed at the surface of an imaginary frustum centred on the central rotational tool axis.

Preferably, each cutting portion has a main portion for chamfering the main portions of the teeth of the workpiece.

In many arrangements, each cutting portion has a second portion for chamfering the root area between adjacent teeth of the workpiece, the second portion being behind the main portion when the tool is rotated in said one direction. Often, there will be a intermediate portion immediately behind the main portion when the tool is rotated in said one direction, said intermediate portion being for shaping the area of the workpiece teeth between the main tooth portions and the root area. Sometimes there will be only the main portion and the intermediate portion if the root area is not being chamfered.

In some embodiments, some or all of the teeth are integrally formed with the central disc portion. In other arrangements, some or all of the teeth are formed as separate elements which are secured to the central disc portion. Commonly, each of the separate elements comprises a single tooth and can be planar.

### BRIEF DESCRIPTION OF THE DRAWINGS

Embodiments of the present invention are described below, the description making reference to the following diagrammatic drawings in which:

FIG. 1 is a schematic perspective view of a tool and workpiece arrangement embodying the tooth chamfering method of the first aspect of the present invention;

FIG. 2 is a schematic perspective view similar to FIG. 1 for chamfering another side of the teeth of the workpiece;

FIG. 3a is a close-up view of part of the workpiece prior to being chamfered;

FIG. 3b is a close-up view similar to FIG. 3a but after chamfering;

FIG. 4 is a view of the workpiece and the tool in the direction X;

FIG. 5 is a view of the workpiece and the tool in the direction Y;

FIG. 6 is a view of the workpiece and the tool in the direction Z;

FIGS. 7a to 7f are close-up sequential views of the teeth of the workpiece and the tool as the teeth pass through a meshing zone;

FIG. 8 is a schematic perspective view of a workpiece and two tools embodying an alternative tooth chamfering method of the present invention;

FIG. 9 is a schematic perspective view similar to FIG. 8 for chamfering another side of the teeth of the workpiece;

FIG. 10 is a schematic perspective view of a workpiece and a tool embodying the second aspect of the present invention;

FIG. 11 is a cross-sectional view through a tool according to the present invention, the tool being suitable for use in the arrangements shown in FIGS. 1 and 10;

FIG. 12 is a side view of the tool in the direction of axis D in FIG. 11;

FIG. 13 is a view of the tool from above in the direction of tool axis A in FIG. 11;

FIG. 14 is a view of an alternative tool from above in the direction of tool axis A; and

FIG. 15 is a view of a further alternative tool from above in the direction of axis A.

### DETAILED DESCRIPTION OF EMBODIMENTS OF THE INVENTION

In the drawings, there is shown a workpiece 10 which is shown as a circular gear having at its circumference a plurality of teeth 11 projecting outwardly from a central disc area 12. In the illustration the teeth 11 are shown as helical teeth but other teeth, such as axially straight teeth, can be chamfered using the present invention. Each tooth 11 has a radially outermost end and a radially innermost root where it meets the root of an adjacent tooth 11. The illustration shows that each tooth 11 has an axially upper end 11a and an axially lower end 11b.

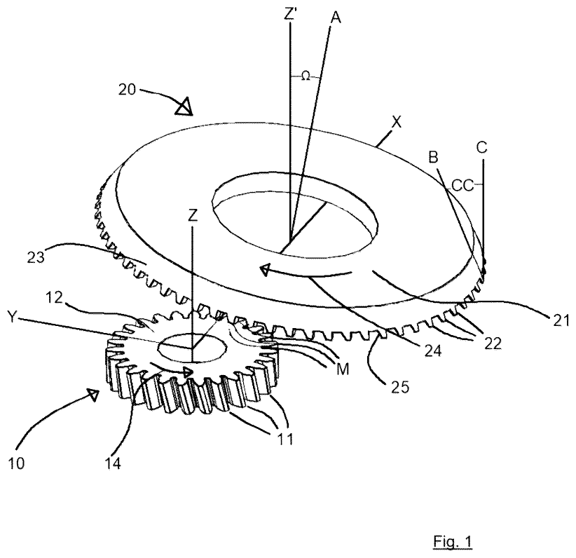

The workpiece 10 has a central rotational axis Z which is perpendicular to the general plane of the workpiece 10 as generally defined by the central disc area 12. The central axis Z defines a workpiece co-ordinate system comprising additional, mutually perpendicular axes X and Y which extend in the radial direction. The workpiece 10 is shown as having a central hole but this is not relevant or necessary to the present invention. The workpiece 10 is mounted for rotation about the central Z axis as illustrated by the arrow 14 which, in FIG. 1, indicates that the workpiece 10 is rotating anti-clockwise about central axis Z. The actual mechanism for rotating the workpiece 10 is not shown for simplicity, such mechanisms being well-known in the field of metalworking.

The Figures also show a chamfering tool 20 which is generally circular in form as defined by a central disc area 21. The tool 20 has a central rotational axis A which is perpendicular to the general plane of the tool 20 as generally defined by the central disc area 21. The tool 20 has a plurality of teeth 22 projecting from the disc area 21. In the illustrated arrangement the teeth 22 project at an angle relative to the central axis A and hence at an angle CC to an imaginary axis C which is parallel to the tool central axis A. The teeth 22 are shown as projecting in alignment with an angled disc surface 23 which extends circumferentially of the central disc area 21 but surface 23 need not be in alignment with the radially outward facing surfaces 23a of the teeth themselves.

The tool 20 is mounted for rotation about its central axis A as illustrated by the arrow 24 which, in FIG. 1, indicates that the tool 20 is rotating clockwise about central axis A. Again, the actual mechanism for rotating the tool 20 is not shown for simplicity, such mechanisms being well-known in the field of metalworking.

Each tooth 22 of the tool 20 has a cutting portion 25 at a leading edge of the tooth 22 when it is being rotated clockwise as illustrated. The teeth 22 of the tool 20 and the teeth 11 of the workpiece 10 and the respective speeds of rotation of the tool and workpiece are co-ordinated such that the teeth are able to mesh with each other as the tool and workpiece rotate.

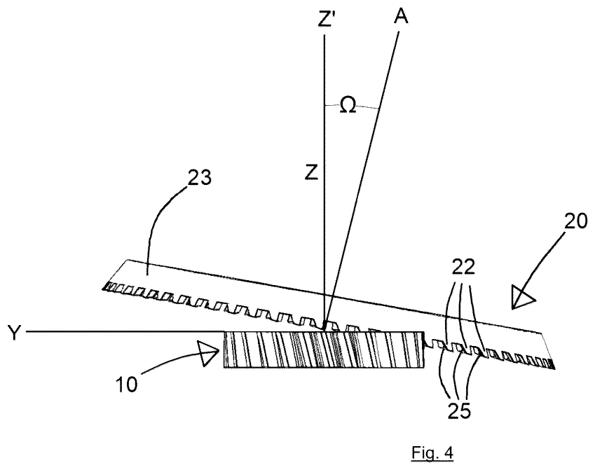

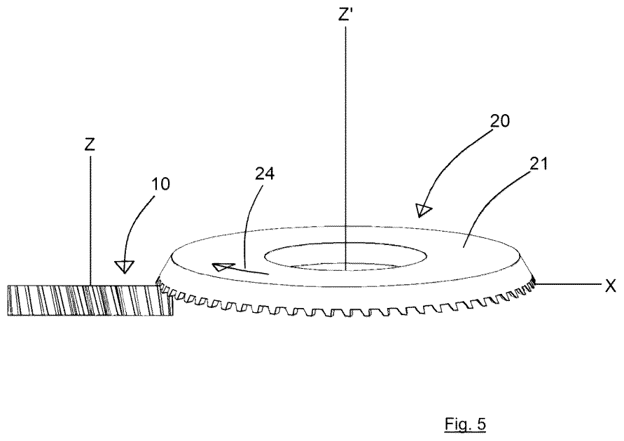

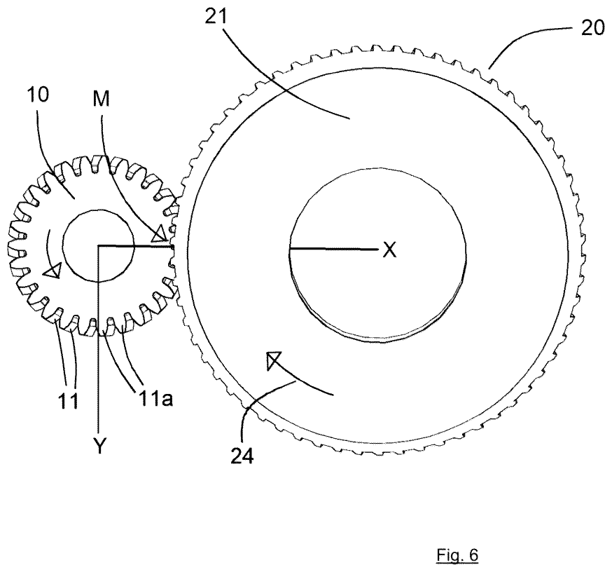

FIGS. 1 and 4 to 6 illustrate the tool 20 arranged to chamfer the trailing edges 15 of workpiece teeth 11. In the present method shown in FIG. 1, the workpiece 10 is rotated about its central axis Z and the tool 20 is rotated about its central axis A. Initially the teeth of the tool 20 and the workpiece are not meshing, the tool and the workpiece simply rotating. The central axis A of the tool during the chamfering process is offset by an angle (relative to an imaginary axis Z′ which is parallel to workpiece central axis Z and which extends through the axis X of the workpiece, axis X extending through a meshing zone M where the teeth of the workpiece and the tool eventually mesh. It will be appreciated that the general plane of the tool 20 is not parallel (or co-planar) with the general plane of the workpiece 10 only by virtue of the tilting of the central tool axis A about the axis X. The tool can be tilted around the Y axis or the Z axis for certain adjustments in the chamfering process.

The tool 20 is then moved towards the workpiece 10 (as both continue to be rotated about their respective central axes A, Z) such that the teeth begin to mesh. In the simplest arrangement, the rotating tool 20 is moved towards the workpiece 10 along the axis Z′ although it is envisaged that in other chamfering processes the tool could be moved in the direction X or Y or any combination of the three axes such that the cutting portions of the tool teeth 22 engage the teeth 11 of the workpiece 10. Much depends on the particular form of chamfer required and the shape of the workpiece teeth.

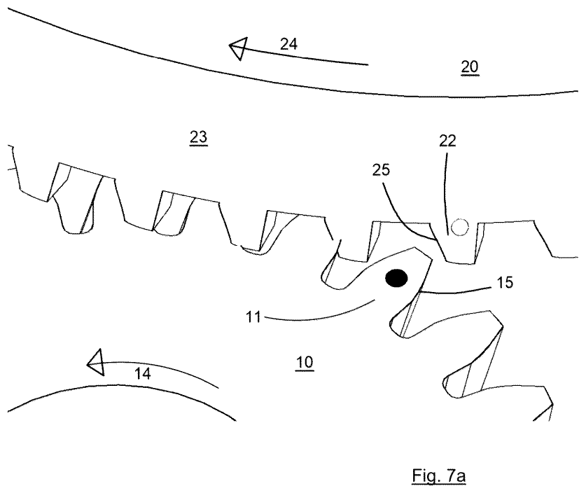

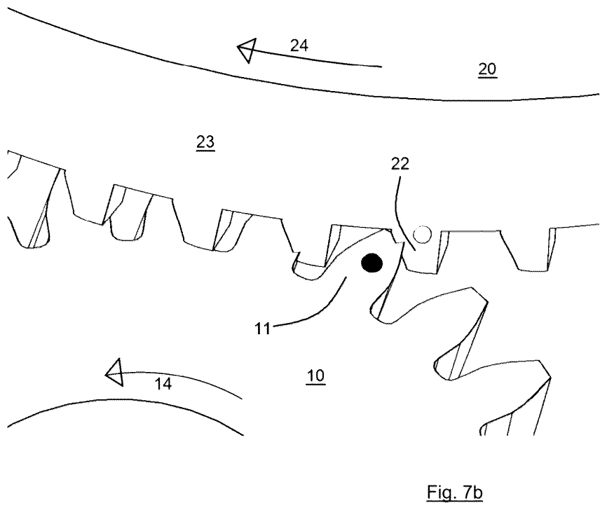

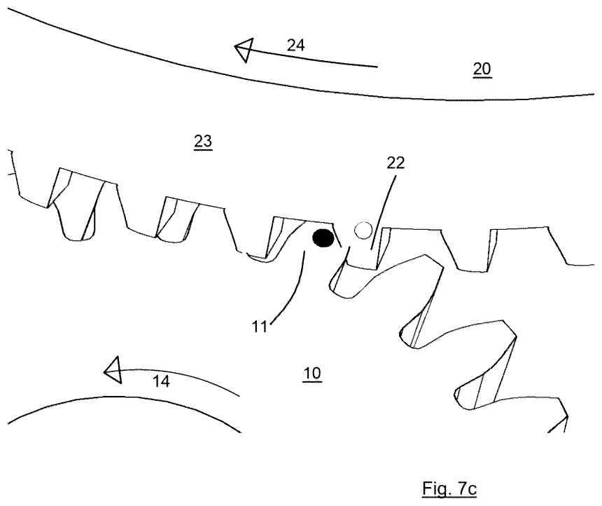

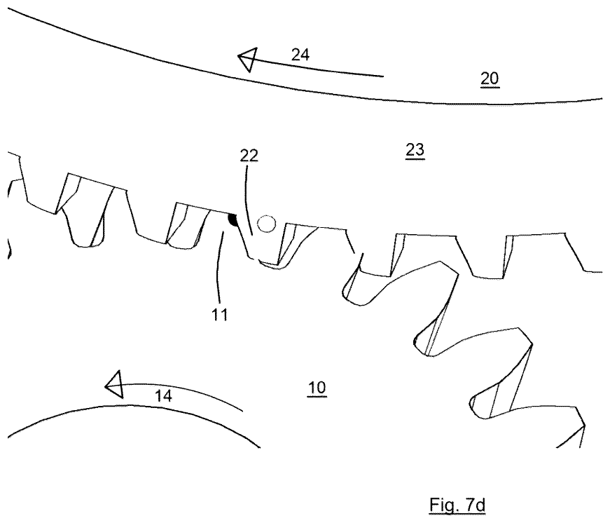

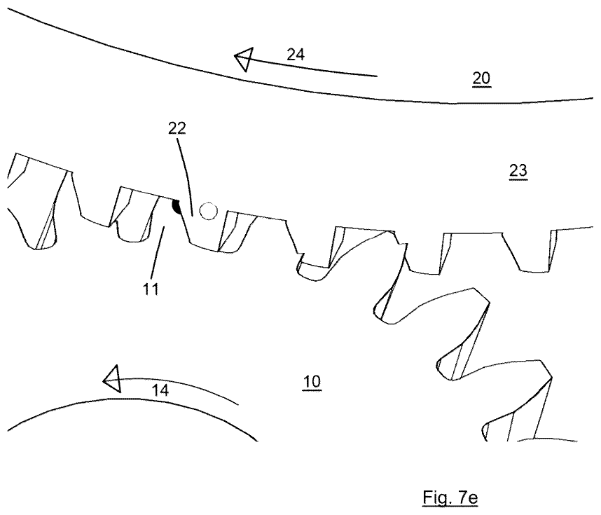

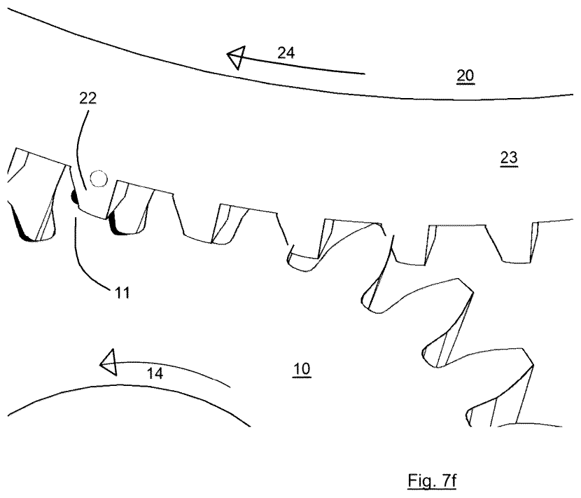

The tool teeth 22 begin to cut into the trailing edges 15 at the axially upper ends 11a of the workpiece teeth. This is shown in more detail in FIGS. 7a to 7f where one tooth 22 on the tool is indexed with a circle and one tooth 11 on the workpiece is indexed with a dot. The FIGS. 7a to 7f show the sequential action of the tooth 22 as the tool and the workpiece rotate, and the tool moves closer to the workpiece. Ultimately, the formation of the chamfer is determined by the rate of movement of the tool towards the workpiece as they both rotate, with a slower movement providing a smoother, more controlled chamfering process.

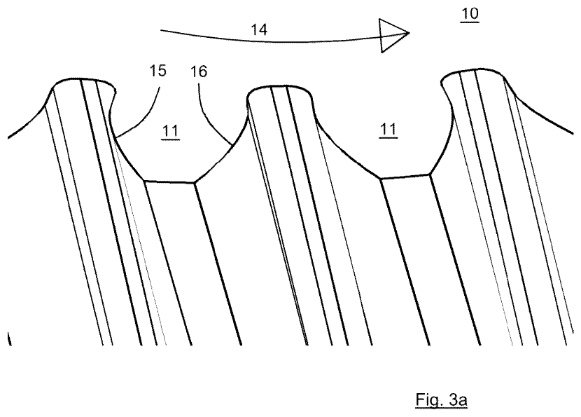

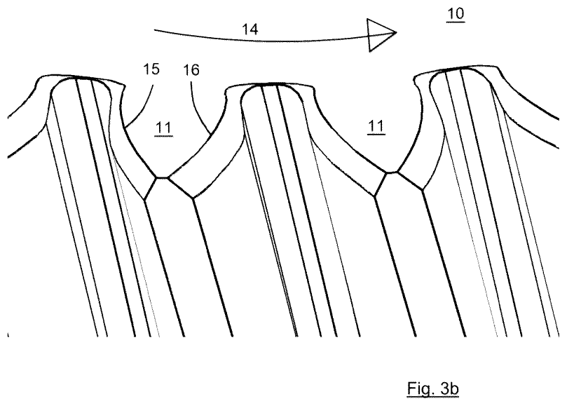

FIG. 3a shows in close-up some exemplary teeth 11 of a workpiece 10 and indicates the trailing edges 15 when the workpiece 10 is being rotated in an anti-clockwise direction indicated by the arrow 14. FIG. 3b shows a similar view of the teeth after chamfering using the method discussed above and the opposite edges 16 have also been chamfered using the method disclosed below.

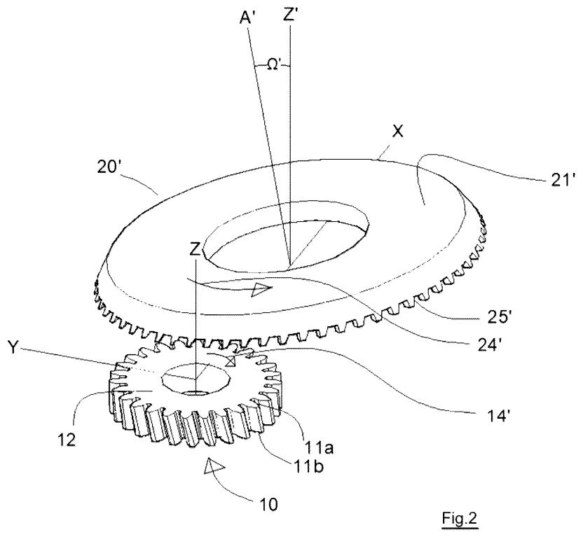

FIG. 2 illustrates the method of chamfering the opposite edges of the workpiece teeth 11, i.e., those edges that are trailing edges when the workpiece is rotated in a clockwise direction. In the FIG. 2 arrangement, a different tool 20′ is used. In construction, the second tool 20′ is similar to the first tool 20 except that the opposite edges of the teeth 22′ are provided with cutting portions 25′. Also, the central axis of rotation A′ of the second tool 20′ is offset by an opposite angle Q′ about the axis X relative to the imaginary axis Z′, and the second tool 20 is rotated in an anti-clockwise direction 24′ about its central axis A′ whilst the workpiece 10 is rotated in a clockwise direction 14′ about workpiece central axis Z.

As with the method described in connection with FIG. 1, the workpiece 10 and the tool 20′ are rotated in the direction of arrows 14′ and 24′ and are initially separate. The tool 20′ is then moved towards the workpiece in the direction of axis Z′ such that the teeth mesh in a similar manner as discussed above except that it is the opposite edges 16 (see FIGS. 3a and 3b) of the workpiece teeth 11 that are chamfered.

In FIG. 7a, the indexed tool tooth is shown approaching the indexed workpiece tooth. In FIG. 7b the tool tooth is cutting into the trailing edge of the workpiece tooth and in FIG. 7c the tool tooth has cut further into the workpiece tooth in the radial direction of the workpiece. In FIG. 7d the tool tooth has almost reached the root of the workpiece tooth. In FIG. 7e the tool tooth is just beginning to clear the workpiece tooth and in FIG. 7f the tool tooth is fully clear of the workpiece tooth. It will be seen from the sequential views 7a to 7f that other teeth of the workpiece i.e., ahead and following the indexed workpiece tooth are also at different stages of chamfering by other workpiece teeth, i.e., those ahead of and following the indexed tool tooth. FIGS. 7e and 7f also indicate by shading the areas of the workpiece that have been chamfered. The process is repeated with the tool moving incrementally closer to the workpiece with each pass of a workpiece tooth in the meshing zone causing slightly more material to be removed until the desired depth of chamfer is achieved.

In the embodiments described above, the method of chamfering has involved (FIG. 1) the use of a single tool 20 creating a chamfer at one edge of each of the workpiece teeth at one axial end of the workpiece teeth (the axially upper end of the teeth as illustrated). The second tool 20′ is then used (FIG. 2) to chamfer the other edge of each of the workpiece teeth at said one axial end of the workpiece. The other ends of the teeth of the workpiece can then be chamfered by similar processes as FIGS. 1 and 2 but by inverting the workpiece 10 so that the other ends of the teeth are now facing axially upwards towards the tools 20, 20′ or by inverting the tools 20, 20′ so that they mesh with the workpiece 10 from below.

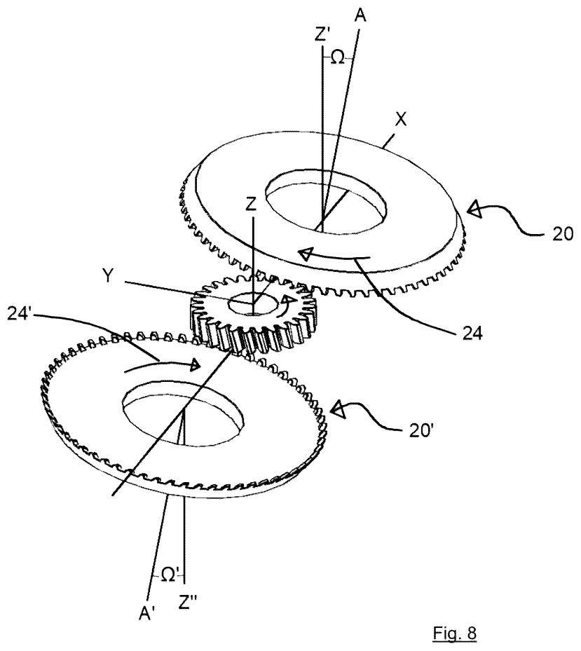

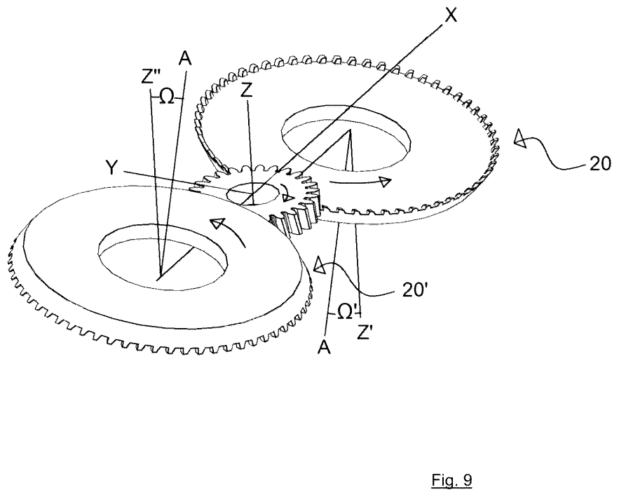

An alternative method of chamfering the teeth of the workpiece 10 is illustrated in FIGS. 8 and 9. FIG. 8 is similar to FIG. 1 in that the workpiece 10 is rotated anti-clockwise about its axis Z and the tool 20 is rotated clockwise with its central axis A offset from the imaginary axis z′ by an angle Q. This produces a chamfer on the trailing edges at the upper axial end of the teeth 11 as discussed above. FIG. 8 additionally shows a tool 20′ similar to that shown in the FIG. 2 arrangement but inverted so as to chamfer lower axial ends of the workpiece teeth 11. Tool 20′ will be rotated about its central axis A′ which is offset from another imaginary axis Z″ (which is also parallel to workpiece axis Z) at an opposite angle Q′. FIG. 9 then shows the tools 20, 20′ inverted to cut the chamfers on the opposite upper and lower edges of the workpiece teeth 11.

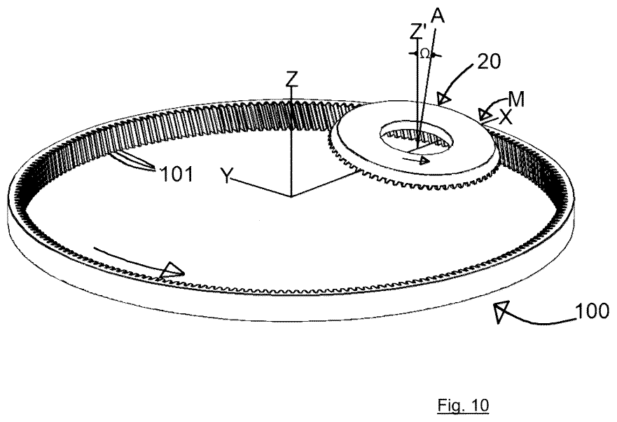

FIG. 10 shows an alternative arrangement embodying the method of the present invention. In FIG. 10 the workpiece 100 is shown with a plurality of teeth 101 projecting inwardly of the workpiece 100. In order to chamfer these teeth 101, the tool 20 is arranged on the inner side of the workpiece 100 and is again mounted for rotation about its axis A which is offset from an imaginary axis Z′ by an angle Q. Similar actions occur when the tool 20 is moved towards the workpiece such that the teeth mesh and the cutting portions of the tool teeth cut into the teeth of the workpiece. In the FIG. 10 arrangement however both the tool 20 and the workpiece 100 are rotated in the same direction (anti-clockwise in the arrangement shown). Similar to other arrangements described above the other edges of the axially upper ends of the workpiece teeth are chamfered with a different tool at an oppositely offset angle Q′ and opposite rotational direction of the tool and workpiece. The lower axial ends of the teeth can then be chamfered by a similar pair of actions. As with the external teeth chamfering shown in FIGS. 8 and 9, two tools could be used simultaneously provided there is sufficient space within the workpiece.

In the above methods, it is considered particularly advantageous if the angles (or Q′ are up to 15°, and preferably not greater than 10º. The small angles Q and Q′ mean that the material cut during the chamfering process (chip) is pushed by the outward facing surfaces 23a of the teeth 11 towards the centre of the workpiece on the upper surface of the central disc area 12 of the workpiece 10, or outwardly in the arrangement shown in FIG. 10. There is no ‘skiving’ action with the present methods. The angle CC of the cutting portions of the teeth 22, 22′ of the tool 20, 20′ can be chosen for chip control.

In the chamfering process, the chamfers on the teeth of the workpiece are formed from the tip to the root of each tooth, as indicated in FIGS. 7a to 7f and in many cases even the roots of the teeth can be chamfered.

It will be appreciated that control means will be provided to control the ratio of rotational speeds of the workpiece and the tool, and that the ratio will be dependent on the ratio of the number of teeth on the workpiece and the number of teeth on the tool. The control means can also control the relative movement between the tool and the workpiece from a non-meshing initial condition to a meshing condition. In the above description, the tool 20, 20′ moves towards the workpiece (from above or below) in a direction parallel to the axis Z′ (Z) while the workpiece is stationery except for its rotation about its central axis Z. It is possible that both the tool and the workpiece could both translate in the direction Z (or parallel thereto) or just the workpiece could move. Additionally, one or both of the tool and the workpiece could also move into engagement with each other in directions parallel to the X and/or Y directions as well as or instead of the Z direction. Much will depend on the geometry of the workpiece teeth and the form of chamfer required.

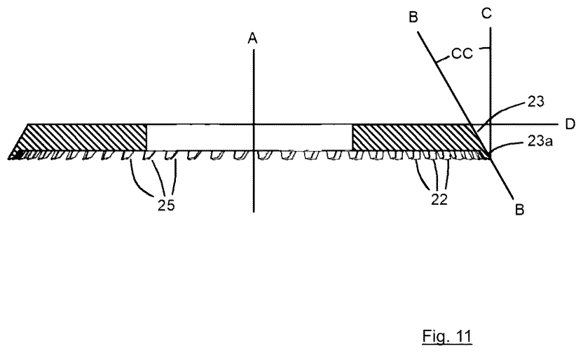

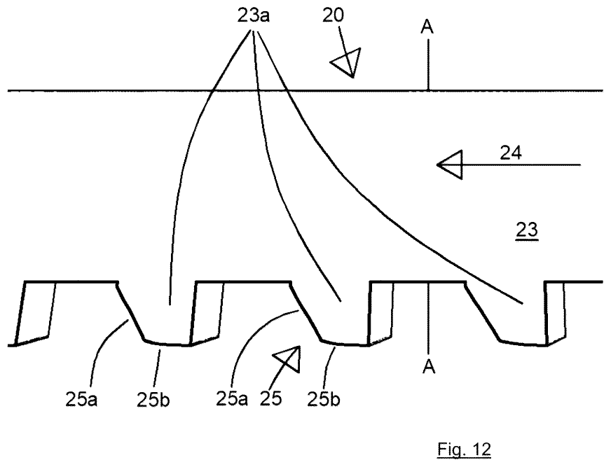

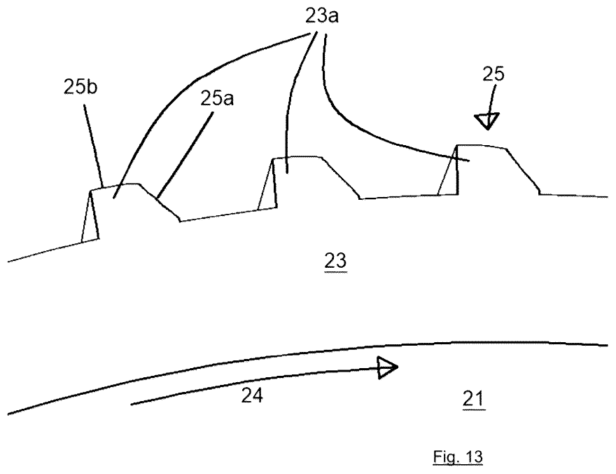

In FIGS. 11 to 15 an illustrative tool 20 is shown in more detail. The tool shown in these figures is generally the same as that shown in FIGS. 1 to 10 although the following paragraphs highlight certain features and alternatives. As stated earlier the radial extremity of the central disc area 21, i.e., surface 23, need not be provided at the same angle as the outer surfaces 23a of the teeth 22 although it makes the tool 20 easier to produce as a unitary component. The surface 23 could therefore be of a different profile or angle compared to the outer surfaces of the teeth 22. The angle CC of the teeth outer surfaces 23a compared to imaginary axis C can be selected depending on the particular chamfering operation for ‘chip control’, i.e., controlling the removal of the material cut from the workpiece teeth 11 during chamfering.

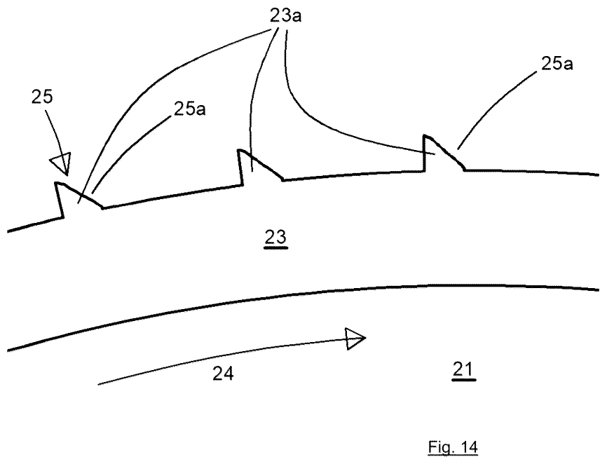

The cutting edge portions 25 of the tool teeth 22 are shown in FIGS. 11 to 13 as being in two parts, namely a first, main cutting portion 25a and a second cutting portion 25b. The first cutting portion 25a is intended to cut the chamfer of the main portion of a workpiece tooth 11 (as is clear from FIG. 7b earlier) and the second cutting portion 25b is intended to cut the chamfer at the root between teeth 11 (as is illustrated best in FIG. 7e), the second cutting portion 25b being closer to being in the general plane of the disc portion of the tool. Although it is not immediately clear from the drawings, there is an (optional) third, intermediate radiused portion of the cutting portion between the first and second cutting portions 25a, 25b, the intermediate radiused portion chamfering a junction between the main tooth areas and the root areas. The precise form of the cutting portions is something of a design choice and will be dependent on the required form of the chamfer in the finished workpiece. For example, FIG. 14 shows a cutting portion which has no second cutting portion, just a first cutting portion 25a. Such a tool can be used when there is no requirement to chamfer the root portion between the teeth 11 of the workpiece 10.

The cutting edge portions 25a and 25b would be disposed at the surface of an imaginary frustum centred on the central rotational tool axis A. In the illustrated embodiments, the radially outer surfaces 23a are also disposed at the surface of that imaginary frustum but need not be. For example, the surfaces 23a may be relieved (or even raised) slightly so as to be disposed slightly inwardly (or outwardly of the surface of the imaginary frustum. As mentioned earlier, the radially outer face of the central disc portion 23 may also be part of the frustum for easier manufacturing but this is not essential.

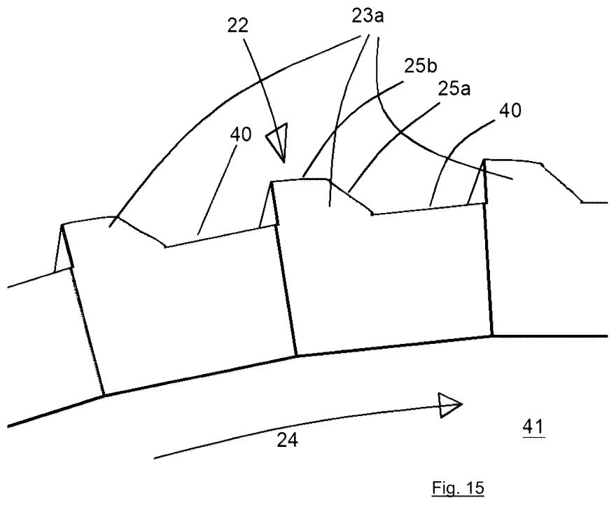

FIG. 15 illustrates that instead of the tool teeth 22 being formed integrally with the central disc area 21 as shown in FIGS. 11 to 14, the teeth 22 could be provided by separate elements 40 (which can be planar) secured to a central disc or hub 41. Such a construction makes it easier to adapt the tool 20 to provide teeth of different geometries and to perform maintenance/sharpening of the cutting portions. Each element 40 may have one or more teeth 22 provided thereon.

With all arrangements, it is also possible that a single tool 20 can be used to chamfer both side of the tooth of the workpiece 10 and this would require cutting portions 25 being provided on both sides of each tool tooth. It is preferred that separate tools are required.

Whilst the workpiece 10, 100 (and hence the tools) is shown with teeth 11 space regularly about its circumference, the present method is also suitable for irregularly spaced teeth on the workpiece or workpieces with blocked sections at the circumference or workpieces with sections with no teeth at the circumference. In such situations it is necessary for the workpiece to have correspondingly toothed sections such that the tool can still mesh with the workpiece in a continuous manner as the tool and the workpiece rotate.

It will be appreciated by the skilled reader that the above-described arrangements are illustrative and that other arrangements will fall within the scope of the attached claims.

What is claimed is:

1. A method of chamfering teeth on a workpiece which has a plurality of outwardly projecting teeth disposed about the circumference of the workpiece and which has a central rotational axis (Z) with the teeth being disposed in a first plane that is perpendicular to the workpiece central axis (Z), the method utilizing a tool which has a plurality of cutting teeth disposed about the circumference of the tool and which has a central rotational tool axis (A) with the cutting teeth disposed in a second plane that is perpendicular to the tool central axis (A), the method comprising the steps of:
i) rotating the workpiece in one direction about its central axis (Z);
ii) rotating the tool in an opposite direction about the tool axis (A), the teeth of the tool each having a cutting portion at a leading edge when the tool is rotated in said opposite direction;
iii) moving the tool and the workpiece towards each other, while the tool and the workpiece are rotating such that the teeth of the tool engage the teeth at an axially facing end of the workpiece at a meshing zone (M), the cutting portions of the tool teeth engaging and cutting into the meshing surfaces of the workpiece teeth at the trailing edges of the workpiece teeth thereby to chamfer said trailing edges of the workpiece teeth;
wherein an axis (X) extends perpendicular to the workpiece central axis (Z) through said meshing zone (M), and the tool axis (A) is tilted at an angle about the axis (X) relative to a direction (Z′) which is an imaginary axis which is parallel to workpiece axis (Z) and which extends through the axis (X), such that the second plane is not parallel to, or co-planar with, the first plane only by virtue of the tilting about the axis (X).

2. The method as claimed in claim 1, wherein the tilt angle about the axis (X) is up to 15°.

3. The method as claimed in claim 2, wherein the tilt angle about the axis (X) is up to 10°.

4. The method as claimed in claim 1, wherein the tool axis (A) is also tilted about the Z′ axis and/or about a further axis perpendicular to axes Z′ and X.

5. The method as claimed in claim 1, wherein the tool is moved towards the workpiece in step iii, the workpiece not moving along its central axis (Z), the tool being moved in one or a combination of:
a. a direction parallel to direction of the axis (Z′);
b. a direction parallel to the direction of the axis (X); and
c. a direction parallel to an axis (Y) which is perpendicular to axes X and Z.

6. The method as claimed in claim 1, wherein the leading edges of the workpiece teeth are chamfered by a reversal of steps i to iii utilizing a tool which has a plurality of cutting teeth disposed about the circumference of the tool and which has a central rotational tool axis (A′) with the cutting teeth disposed in a second plane that is perpendicular to the tool central axis (A′) and the teeth of the tool each having a cutting portion at a leading edge when the tool is rotated in said one direction, namely:
iv) rotating the workpiece in the opposite direction about its central axis (Z) such that the leading edges of the workpiece teeth are effectively trailing edges;
v) rotating the tool in the first direction about the tool axis (A′);
vi) moving the tool and the workpiece towards each other such that the teeth of the tool engage the teeth at said axially facing end of the workpiece at the meshing zone (M), the second cutting portions of the tool teeth engaging and cutting into the now trailing leading edges of the workpiece thereby to chamfer said leading edges of the workpiece teeth;
wherein the tool axis (A′) is tilted at an angle about the axis (X) in the opposite direction relative to direction (Z′) and extends through the axis (X) such that the second plane is not parallel to, or co-planar with, the first plane by virtue of the tilting about the axis (X).

7. The method as claimed in claim 6, wherein the tool utilized to chamfer the trailing edges of the workpiece teeth is a separate tool to the tool utilized to chamfer the leading edges of the workpiece teeth.

8. The method as claimed in claim 1, wherein the method further comprises providing the tool teeth on the cutting tool such that the cutting portions of the teeth are radially spaced from the central tool axis (A) and extend at an angle relative to the central tool axis (A).

9. The method as claimed in claim 8, wherein the tool has a central disc portion and the tool teeth depend from the central disc portion and extend outwardly therefrom at said angle relative to the tool axis.

10. The method as claimed in claim 1, further comprising the step of providing control means to control (a) the movement of the tool or tools and the workpiece towards each other and (b) the relative speeds of rotation of the tool or tools and the workpiece thereby to control the amount of chamfer and the rate of material removal in the chamfering process.

11. The method as claimed in claim 10, wherein the control means is configured to control the distance between the workpiece axis (Z) and the imaginary axis (Z′) thereby to control the radial extent of the chamfer formed on the workpiece teeth.

12. The method as claimed in claim 1, wherein the axially facing opposite ends of the teeth of the workpiece are chamfered simultaneously with the first-mentioned axially facing ends of the workpiece, the method comprising the step of providing a further tool similar to the first-mentioned tool and effecting steps i to iii on the axially opposite facing ends of teeth of the workpiece, the further tool being positioned so as not to interfere with the first-mentioned tool during chamfering.

13. A method of chamfering teeth on a workpiece which has a plurality of inwardly projecting teeth disposed about the circumference of the workpiece and which has a central rotational axis (Z) with the teeth being disposed in a first plane that is perpendicular to the workpiece central axis (Z), the method utilizing a tool which has a plurality of cutting teeth disposed about the circumference of the tool and which has a central rotational tool axis (A) with the cutting teeth disposed in a second plane that is perpendicular to the tool central axis (A), the method comprising the steps of:
i) rotating the workpiece in one direction about its central axis (Z);
ii) rotating the tool in said one direction about the tool axis (A), the teeth of the tool each having a cutting portion at a leading edge when the tool is rotated in said one direction;
iii) moving the tool and the workpiece towards each other, while the tool and the workpiece are rotating, such that the teeth of the tool engage the teeth at an axially facing end of the workpiece at a meshing zone (M), the cutting portions of the tool teeth engaging and cutting into the meshing surfaces of the workpiece teeth at the trailing edges of the workpiece teeth thereby to chamfer said trailing edges of the workpiece teeth;
wherein an axis (X) extends perpendicular to the workpiece central axis (Z) through said meshing zone (M), and the tool axis (A) is tilted at an angle about the axis (X) relative to the direction (Z′) which is an imaginary axis which is parallel to workpiece axis (Z) and which extends through the axis (X), such that the second plane is not parallel to, or co-planar with, the first plane only by virtue of the tilting about the axis (X).

14. A tool for use in the chamfering of teeth on a workpiece which has a plurality of projecting teeth disposed about the circumference of the workpiece, the tool comprising:
a central disc portion;
a central rotational tool axis, the central disc portion extending in a first general plane that is perpendicular to the central rotational tool axis; and
a plurality of cutting teeth disposed about the outer circumference of the tool; wherein the teeth of the tool each have a cutting portion at a leading edge when the tool is rotated in one direction about said central rotational tool axis such that the cutting portions of the teeth are radially spaced from the central tool axis and all the cutting portions would be disposed at the surface of an imaginary frustum centred on the central rotational tool axis.

15. The tool as claimed in claim 14, wherein each cutting portion has a main portion for chamfering the main portions of the teeth of the workpiece.

16. The tool as claimed in claim 15, wherein each cutting portion has a second portion for chamfering the root area between adjacent teeth of the workpiece, the second portion being behind the main portion when the tool is rotated in said one direction.

17. The tool as claimed in claim 15, wherein each cutting portion has an intermediate portion immediately behind the main portion when the tool is rotated in said one direction.

18. The tool as claimed in claim 14, wherein some or all of the teeth are integrally formed with the central disc portion.

19. The tool as claimed in claim 14, wherein some or all of the teeth are formed as separate elements which are secured to the central disc portion.

20. The tool as claimed in claim 19, wherein each of the separate elements comprises a single tooth.

21. The tool as claimed in claim 19, wherein each of the separate elements are planar.

22. The tool as claimed in claim 14, wherein the tool is in the form of a crown gear.

23. The tool as claimed in claim 14, wherein the tool teeth depend from the central disc portion and protrude from the central disc portion in axial direction of the central rotational tool axis.

24. The tool as claimed in claim 14, wherein the cutting portions of the tool teeth and an outward facing surface of the central disc portion are arranged in succession along the central rotational tool axis.
